(19) United States
(12) Patent Application Publication
(10) Pub. No.: US 2016/0042847 A1
(43) Pub. Date: Feb. 11, 2016

(54) R-T-B BASED SINTERED MAGNET

(71) Applicant: HITACHI METALS, LTD., Tokyo (JP)

(72) Inventors: Takeshi NISHIUCHI, Mishima-gun (JP); Futoshi KUNIYOSHI, Mishima-gun (JP); Rintaro ISHII, Mishima-gun (JP); Tsunehiro KAWATA, Mishima-gun (JP)

(73) Assignee: HITACHI METALS, LTD., Tokyo (JP)

(21) Appl. No.: 14/780,264

(22) PCT Filed: Mar. 27, 2014
(86) PCT No.: PCT/JP2014/058737

§ 371 Date: Sep. 25, 2015

(30) Foreign Application Priority Data
Mar. 29, 2013 (JP) 2013-071833

(51) Int. Cl. H01F 1/055; C22C 38/10; H01F 7/02; C22C 38/00; B22F 7/00; C22C 38/16; C22C 38/06

(52) U.S. Cl. CPC H01F 1/0557; C22C 38/16; C22C 38/10; C22C 38/06; C22C 38/005; C22C 38/002; C22C 38/001; B22F 7/008; H01F 7/02

(57) ABSTRACT

To provide an R-T-B based sintered magnet having high Bᵣ and high H_{cJ} without using Dy by solving a problem that a significant reduction in Bᵣ due to a decrease in B concentration and H_{cJ} are insufficient to satisfy recent requirements. Disclosed is an R-T-B based sintered magnet which includes an Nd₂Fe₁₄B type compound as a main phase, and comprises the main phase, a first grain boundary phase located between two main phases, and a second grain boundary phase located between three or more main phases, wherein the first grain boundary phase having a thickness of 5 nm or more and 30 nm or less is present.

### TECHNICAL FIELD

The present invention relates to an R-T-B based sintered magnet.

### BACKGROUND ART

An R-T-B based sintered magnet including an Nd₂Fe₁₄B type compound as a main phase (R is at least one of rare-earth elements and inevitably includes Nd, and T is a transition metal element and inevitably includes Fe) has been known as a permanent magnet with the highest performance among permanent magnets, and has been used in various motors for hybrid vehicles, electric vehicles, and home appliances.

However, in the R-T-B based sintered magnet, coercivity H_{cJ} (hereinafter sometimes simply referred to as “H_{cJ}”) decreases at an elevated temperature to cause irreversible thermal demagnetization. Therefore, when used particularly in motors for hybrid vehicles and electric vehicles, there is a need to maintain high H_{cJ} even at an elevated temperature.

To increase H_{cJ}, numerous heavy rare-earth elements (mainly, Dy) have hitherto been added to the R-T-B based sintered magnet. However, there arose a problem that a residual magnetic flux density Br (hereinafter sometimes simply referred to as “Bᵣ”) decreases. Therefore, there has recently been employed a method in which heavy rare-earth elements are diffused from the surface into the inside of the R-T-B based sintered magnet to thereby increase the concentration of the heavy rare-earth elements at the outer shell part of main phase crystal grains, thus obtaining high H_{cJ} while suppressing a decrease in Bᵣ.

Dy has problems such as unstable supply and price fluctuations because of restriction of the producing district. Therefore, there is a need to develop technology for increasing H_{cJ} of the R-T-B based sintered magnet without using heavy rare-earth elements such as Dy as much as possible.

Patent Document 1 discloses that a B concentration is decreased as compared with a conventional R-T-B-based alloy and one or more metal elements M selected from among Al, Ga, and Cu are included to form an R₂T₁₇ phase, and a volume fraction of a transition metal-rich phase (R₆T₁₃M) formed from the R₂T₁₇ phase as a raw material is sufficiently secured to obtain an R-T-B-based rare-earth sintered magnet having high coercivity while suppressing the content of Dy.

### PRIOR ART DOCUMENT

### Patent Document

Patent Document 1: WO 2013/008756 A

### SUMMARY OF THE INVENTION

### Problems to be Solved by the Invention

However, Patent Document 1 had a problem that since the B concentration is significantly decreased than usual, an existence ratio of a main phase decreases, leading to a significant reduction in Bᵣ. Although H_{cJ} increases, H_{cJ} is insufficient to satisfy recent requirements.

The present invention has been made so as to solve the above problems and an object thereof is to provide an R-T-B based sintered magnet having high Bᵣ and high H_{cJ} without using Dy.

### Means for Solving the Problems

An aspect 1 of the present invention is directed to an R-T-B based sintered magnet which includes an Nd₂Fe₁₄B type compound as a main phase, and comprises the main phase, a first grain boundary phase located between two main phases, and a second grain boundary phase located between three or more main phases, wherein the first grain boundary phase having a thickness of 5 nm or more and 30 nm or less is present.

An aspect 2 of the present invention is directed to the R-T-B based sintered magnet in the aspect 1, wherein the composition of the R-T-B based sintered magnet comprises:

R: 13.0 atomic % or more and 15 atomic % or less (R being Nd and/or Pr),

B: 5.2 atomic % or more and 5.6 atomic % or less,

Ga: 0.2 atomic % or more and 1.0 atomic % or less,

Al: 0.69 atomic % or less (including 0 atomic %), and balance being T (T is a transition metal element and inevitably includes Fe) and inevitable impurities.

An aspect 3 of the present invention is directed to the R-T-B based sintered magnet in the aspect 2, which further includes:

Cu: 0.01 atomic % or more and 1.0 atomic % or less.

An aspect 4 of the present invention is directed to the R-T-B based sintered magnet in the aspect 2 or 3, wherein the content of Al is 0.3 atomic % or less (including 0 atomic %).

An aspect 5 of the present invention is directed to the R-T-B based sintered magnet according to any one of the aspects 2 to 4, wherein the content of B is 5.2 atomic % or more and 5.43 atomic % or less.

An aspect 6 of the present invention is directed to the R-T-B based sintered magnet according to any one of the aspects 2 to 5, which satisfies the following inequality expression (1):

0.8≦<Ga>/( 1/17×100−<B>)≦3.0 (1)

wherein <Ga> is the amount of Ga in terms of atomic %, and <B> is the amount of B in terms of atomic %.

An aspect 7 of the present invention is directed to the R-T-B based sintered magnet in the aspect 6, which satisfies the following inequality expression (2):

1.03≦<Ga>/( 1/17×100−<B>)≦1.24 (2)

where <Ga> is the amount of Ga in terms of atomic %, and <B> is the amount of B in terms of atomic %.

An aspect 8 of the present invention is directed to the R-T-B based sintered magnet according to the aspect 3 or any one of the aspects 4 to 7 citing the aspect 3, which satisfies the following inequality expression (3):

1.0≦<Ga+Cu>/( 1/17×100−<B>)≦3.0 (3)

wherein <Ga+Cu> is the total amount of Ga and Cu in terms of atomic %, and <B> is the amount of B in terms of atomic %

An aspect 9 of the present invention is directed to the R-T-B based sintered magnet in any one of the aspects 1 to 8, wherein the first grain boundary phase has a thickness of 10 nm or more and 30 nm or less.

An aspect 10 of the present invention is directed to the R-T-B based sintered magnet in any one of the aspects 2 to 9, wherein an atomic number ratio of the amount of B to the amount of R satisfies the following inequality expression (4):

0.37≦<B>/<R>≦0.42 (4)

wherein <B> is the amount of B in terms of atomic %, and <R> is the amount of R in terms of atomic %.

An aspect 11 of the present invention is directed to the R-T-B based sintered magnet in any one of the aspects 2 to 10, wherein the content of Fe or (Fe+Co) of the first grain boundary phase is 20 atomic % or less (including 0 atomic %).

### Effects of the Invention

According to the present invention, it is possible to provide an R-T-B based sintered magnet having high Bᵣ and high H_{cJ} without using Dy.

### BRIEF DESCRIPTION OF THE DRAWINGS

FIG. 1 is a graph showing the results of Bᵣ and in Table 2.

FIGS. 2(a) and 2(b) are schematic views for explaining a method for measuring a thickness of a first grain boundary phase.

### MODE FOR CARRYING OUT THE INVENTION

The inventors have intensively studied so as to solve the above problems and found that, as shown in the aspect 1 of the present invention, an R-T-B based sintered magnet having high Bᵣ and high H_{cJ} is obtained without using Dy through the existence of a first grain boundary phase having a thickness of 5 nm or more and 30 nm or less (hereinafter sometimes referred to as a “two-grain boundary phase”) in an R-T-B based sintered magnet.

There are still unclear points regarding the mechanism in which an R-T-B based sintered magnet having high Bᵣ and high H_{cJ} is obtained without using Dy by the existence of a first grain boundary phase having a thickness of 5 nm or more and 30 nm or less. A description will be made on the mechanism proposed by the inventors based on the findings they have had so far. It is to be noted that the description regarding the following mechanism is not intended to limit the technical scope of the present invention.

It is considered that the composition and the thickness of the first grain boundary phase (two-grain boundary phase) in the R-T-B based sintered magnet exerts a significant influence on the magnetization reversal behavior of the R-T-B based sintered magnet. For example, if the two-grain boundary phase has a small thickness, it is impossible to sufficiently decouple magnetic interaction between crystal grains. Therefore, it is expected that magnetization reversal easily propagates over crystal grains, thus making it difficult to obtain high H_{cJ}. It is considered to secure a sufficient amount of a liquid phase (grain boundary phase) during sintering or heat treating so as to increase the thickness of the two-grain boundary phase. However, even if the amount of R is merely increased to increase the amount of a liquid phase in an Nd₁₄Fe₈₀B₆ alloy employed generally as the R-T-B based sintered magnet, the thickness of the two-grain boundary phase to be measured by the technique such as TEM (transmission electron microscope) is at most 5 nm, thus making it difficult to further increase the thickness.

By noticing the fact that numerous Fe is present in the two-grain boundary phase, which has recently become clear, (disclosed, for example, in Document Name: H. Sepehri-Amin. et. al, Acta Materialia 60, P819 (2012)), the inventors have considered that physical properties of the two-grain boundary phase, on which numerous Fe is present, might have contributed to suppress the thickness of the two-grain boundary phase from increasing sufficiently. As a result of an intensive study, the inventors have found that the amount of B in the R-T-B based sintered magnet is lowered than a stoichiometric ratio and Ga is included to thereby form an R-T-Ga phase in the grain boundary phase in place of an R₂T₁₇ phase, leading to a decrease in content of Fe in the two-grain boundary phase, and that the thickness of the two-grain boundary phase can be increased by forming an R phase and R-Ga phase in the two-grain boundary phase when including no Cu, or forming an R phase, R-Ga phase and an R-Ga—Cu phase in the two-grain boundary phase when including Cu.

However, the R-T-Ga phase sometimes has slight magnetization and if the R-T-Ga phase excessively exists in the two-grain boundary phase particularly in charge of H_{cJ}, magnetization of the R-T-Ga phase may prevent the thickness of the two-grain boundary phase from increasing. If the amount of B is excessively decreased so as to form the R-T-Ga phase, an existence ratio of a main phase decreases, thus having possibility to fail to obtain high Bᵣ. Therefore, if the R phase and R-Ga phase, or the R phase, R-Ga phase and R-Ga—Cu phase can be formed while suppressing the R-T-Ga phase from forming as small as possible in the two-grain boundary phase, the thickness of the two-grain boundary phase can be further increased, thus enabling an increase in H_{cJ}. However, if formation of the R-T-Ga phase is excessively suppressed, it is impossible to sufficiently form the R phase and R-Ga phase, or the R phase, R-Ga phase and R-Ga—Cu phase.

In one embodiment, the precipitation amount of an R₂T₁₇ phase is adjusted by controlling the amount of R and the amount of B within an appropriate range, and also the R phase and R-Ga phase, or the R phase, R-Ga phase and R-Ga—Cu phase can be formed while suppressing the R-T-Ga phase from forming as small as possible by setting the amount of Ga within an optimum range corresponding to the precipitation amount of the R₂T₁₇ phase, whereby, it becomes impossible to suppress the thickness of the two-grain boundary phase from increasing and also a decrease in existence ratio of a main phase is suppressed, thus making it possible to more certainly obtain an R-T-B based sintered magnet having high Bᵣ and high H_{cJ}.

The “thickness of a first grain boundary phase (two-grain boundary phase)” in the present invention means a thickness of a first grain boundary phase located between two main phases, and more specifically means a maximum value of the thickness when measuring a region having the largest thickness of the grain boundary phase. The “thickness of a first grain boundary phase (two-grain boundary phase)” is evaluated by the following procedures.

1) Five or more visual fields, each including a two-grain boundary phase of which the length in an observation cross section is 3 μm or more in a scanning electron microscope (SEM) observation, are selected at random.

2) For each visual field, a sample is processed so as to include the two-grain boundary phase by a microsampling method using focused ion beam (FIB). Furthermore, the sample was subjected to slice processing until the thickness became 80 nm or less.

3) The thin piece sample thus obtained is observed by a transmission electron microscope (TEM) to determine a maximum value in individual two-grain grain boundaries. As a matter of course, after determining the region where the thickness of the two-grain boundary phase is the largest, a magnification of TEM may be increased so as to accurately measure the thickness when the maximum value of the thickness of the region is measured.

4) An average of all two-grain grain boundaries observed by the procedures 1) to 3) is determined.

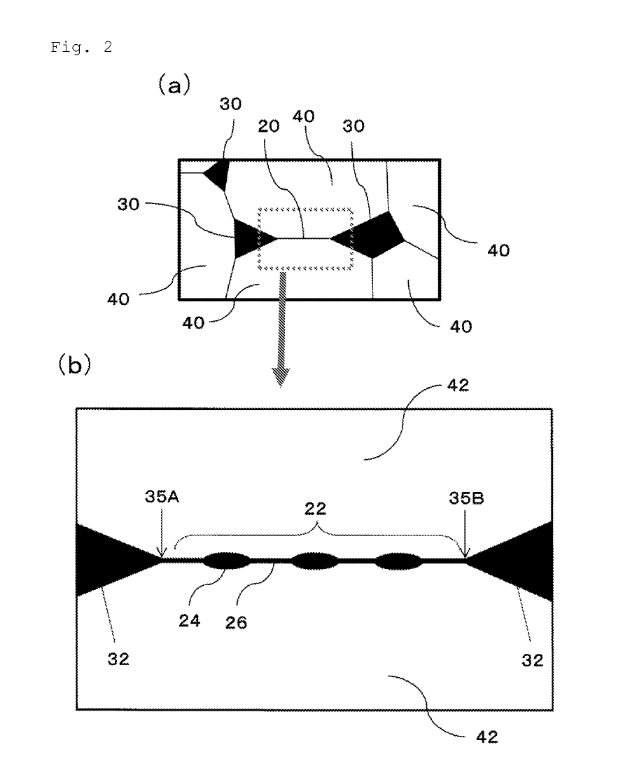

FIG. 2(a) is a view schematically showing an example of a first grain boundary phase, and FIG. 2(b) is an enlarged view of a part encircled by a dotted line in FIG. 2(a).

As shown in FIG. 2(b), a region having a large thickness 24 and a region having a small thickness 26 sometimes coexist in a first grain boundary phase 22. In such case, a maximum value of the thickness of the region having a large thickness 24 is regarded as the thickness of the first grain boundary phase 22. As shown in FIG. 2(b), the first grain boundary phase 22 is sometimes connected to a second grain boundary phase 32 located between three or more main phases 42. In this case, regarding “thickness of a first grain boundary phase”, the thickness near the border, at which the boundary changes from the first grain boundary phase 22 to the second grain boundary phase 32 in a cross section of a magnet whose thickness is to be measured (the region within about 0.5 μm from the border 35A, 35B between the first grain boundary phase 22 and the second grain boundary phase 32), will not be measured. This is because there is a possibility that the border is influenced by the thickness of the second grain boundary phase 32. In FIG. 2(b), the range indicated by brace designated by reference numeral 22 denotes the range where the first grain boundary phase 22 extends, and it is to be noted that said range does not necessarily denote the range where the thickness of first grain boundary phase 22 is to be measured (i.e. the range excluding the region within about 0.5 μm from the border 35A, 35B).

In the present invention, high Bᵣ and H_{cJ} can be obtained by allowing a first grain boundary phase having a thickness of 5 nm or more and 30 nm or less to be present. If the thickness of the first grain boundary phase is less than 5 nm, it is impossible to sufficiently decouple magnetic interaction between crystal grains, thus failing to obtain high H_{cJ}. Meanwhile, if the thickness of the first grain boundary phase is more than 30 nm, high H_{cJ} can be obtained. However, the existence ratio of the main phase decreases, thus having possibility to fail to obtain high Bᵣ. The thickness of the first grain boundary phase is preferably within a range of 10 nm or more and 30 nm or less.

### [Composition of R-T-B-Based Sintered Magnet]

Preferred composition of an R-T-B based sintered magnet according to one embodiment of the present invention is as follows:

R: 13.0 atomic % or more and 15 atomic % or less (R being Nd and/or Pr),

B: 5.2 atomic % or more and 5.6 atomic % or less,

Ga: 0.2 atomic % or more and 1.0 atomic % or less,

Al: 0.3 atomic % or less (including 0 atomic %), and

balance being T (T is Fe, and 10% or less of Fe is capable of being replaced with Co) and inevitable impurities.

Alternatively, preferred composition of an R-T-B based sintered magnet according to one embodiment of the present invention is as follows:

R: 13.0 atomic % or more and 15 atomic % or less (R being Nd and/or Pr),

B: 5.2 atomic % or more and 5.6 atomic % or less,

Ga: 0.2 atomic % or more and 1.0 atomic % or less,

Cu: 0.01 atomic % or more and 1.0 atomic % or less,

Al: 0.3 atomic % or less (including 0 atomic %), and balance being T (T is Fe, and 10% or less of Fe is capable of being replaced with Co) and inevitable impurities.

High Bᵣ and high H_{cJ} can be obtained by combining the amount of R, the amount of B, and the amount of Ga within the above range. If any one of the amount of R, the amount of B, and the amount of Ga deviates from the above range, formation of the R-T-Ga phase excessively decreases, and in the entire R-T-B based sintered magnet, the two-grain boundary phase, on which the R phase and R-Ga phase, or the R phase, R-Ga phase and R-Ga—Cu phase is/are not formed, increases, thus failing to increase the thickness of the two-grain boundary phase. Meanwhile, if the R-T-Ga phase is excessively formed in the grain boundary phase, magnetization of the R-T-Ga phase suppresses magnetic separation between crystal grains, and also suppresses the thickness of the two-grain boundary phase from increasing in the entire R-T-B based sintered magnet.

R is Nd and/or Pr. The content of R is set within a range of 13 atomic % or more and 15 atomic % or less. The content of B is set within a range of 5.2 atomic % or more and 5.6 atomic % or less. The content of Ga is 0.2 atomic % or more and 1.0 atomic % or less, and preferably 0.4 atomic % or more and 0.6 atomic % or less. Balance T is Fe, and 10% or less of Fe is capable of being replaced with Co. It is not preferable that the amount of Co substitution of more than 10% leads to a reduction in Bᵣ.

In addition to each element mentioned above, 0.01 atomic % or more and 1.0 atomic % or less of Cu may be included. Inclusion of Cu lead to formation of an R-Ga—Cu phase in the two-grain boundary phase, together with an R phase and an R-Ga phase. Formation of the R-Ga—Cu phase leads to a further increase in H_{cJ} as compared with the case of the R-Ga phase alone. The magnet may include the same degree of Al content as usual. The range of amount of Al where known effects are exerted is set at 0.3 atomic % or less (including 0 atomic %).

In the present invention, the R-T-Ga phase may include: R: 15% by mass or more and 65% by mass or less (preferably, R: 40% by mass or more and 65% by mass or less), T: 20% by mass or more and 80% by mass or less, Ga: 2% by mass or more and 20% by mass or less (when the content of R is 40% by mass or more and 65% by mass or less, the content of T may be 20% by mass or more and 55% by mass or less, and the content of Ga may be 2% by mass or more and 15% by mass or less), and examples thereof include an R₆Fe₁₃Ga₁ compound having an La₆Co₁₁Ga₃-type crystal structure. The R-T-Ga phase may include other elements except for the above-mentioned R, T, and Ga. The R-T-Ga phase may contain, as these other elements, one or more elements selected from such as Al and Cu. The R phase may include 95% by mass or more of R, and examples thereof include Nd metal having a dhcp structure. The R-Ga phase may include 70% by mass or more and 95% by mass or less of R, 5% by mass or more and 30% by mass or less of Ga, and 20% by mass or less (including 0) of Fe, and examples thereof include an R₃Ga₁ compound. The R-Ga—Cu phase may be a phase in which Ga of the R-Ga phase is partially replaced with Cu, and examples thereof include an R₃ (Ga, Cu)₁ compound. The R-Ga phase sometimes forms a phase with Fe-poor composition, which has other structures such as an amorphous structure.

In the present invention, the content of Fe or (Fe+Co) of a first grain boundary phase located between two main phases (i.e. two-grain boundary phase) is preferably 20 atomic % or less (including 0 atomic %). This is because the thickness of the two-grain boundary phase can be increased by decreasing the concentration of Fe or (Fe+Co) in the two-grain boundary phase. A decrease in concentration of (Fe+Co) also has the effect capable of increasing H_{cJ} by decoupling magnetic interaction between main phases.

The amount of B in the present invention is set at the amount lower than the amount of B ( 1/17×100 (=5.88 atomic %)) defined in the stoichiometric composition of the R₂T₁₄B phase. Therefore, if Ga and Cu are not included within a range which corresponds with deficit of the amount of B (i.e. 1/17×100−<B>) (<B> is the amount of B in terms of atomic %), an R₂T₁₇ phase is formed in addition to an R-T-Ga phase, leading to a reduction in H_{cJ}. Whereas, if Ga and Cu excessively exist, the proportion of the main phase (R₂T₁₄B phase) decreases, thus failing to obtain high Bᵣ. Therefore, it is preferable to determine the addition amounts of Ga and Cu corresponding with deficit of the amount of B (i.e. 1/17×100−<B>). Specifically, when the composition includes no Cu, the content of Ga, namely, <Ga>/( 1/17×100−<B>) (<Ga> is the amount of Ga in terms of atomic %) is preferably 0.8 or more and 3.0 or less in terms of an atomic number ratio. When including Cu, the contents of Ga and Cu, namely, <Ga+Cu>/( 1/17×100−<B>) (<Ga+Cu> is the total amount of Ga and Cu in terms of atomic %) is preferably 1.0 or more and 3.0 or less in terms of an atomic number ratio. Furthermore, the amount of R and the amount of B, that is, <B>/<R>(<R> is the amount of R in terms of atomic %) is preferably 0.37 or more and 0.42 or less in terms of an atomic number ratio. In any case, a reduction in Bᵣ is more suppressed and also H_{cJ} is more increased by adjusting to a preferable range.

In another preferred embodiment of the present invention, preferred composition of the R-T-B based sintered magnet is as follows:

R: 13.0 atomic % or more and 15 atomic % or less (R being Nd and/or Pr),

B: 5.2 atomic % or more and 5.6 atomic % or less,

Ga: 0.2 atomic % or more and 1.0 atomic % or less,

Al: 0.69 atomic % or less (including 0 atomic %), and

balance being T (T is a transition metal element, and inevitably includes Fe) and inevitable impurities.

High Bᵣ and high H_{cJ} can be obtained by combining the amount of R, the amount of B, and the amount of Ga within the above range. If any one of the amount of R, the amount of B, and the amount of Ga deviates from the above range, formation of the R-T-Ga phase excessively decreases or increases. If the R-T-Ga phase excessively decreases, the two-grain boundary phase, on which the R phase and R-Ga phase, or the R phase, R-Ga phase and R-Ga—Cu phase is/are not formed, increases in the entire R-T-B based sintered magnet, thus failing to increase the thickness of the two-grain boundary phase. Meanwhile, if the R-T-Ga phase is excessively formed in the grain boundary phase, magnetization of the R-T-Ga phase suppresses magnetic separation between crystal grains in the entire R-T-B based sintered magnet, and also suppresses the thickness of the two-grain boundary phase from increasing.

R is Nd and/or Pr. The content of R is set within a range of 13 atomic % or more and 15 atomic % or less. The content of B is 5.2 atomic % or more and 5.6 atomic % or less, and preferably 5.2 atomic % or more and 5.43 atomic % or less. The content of Ga is 0.2 atomic % or more and 1.0 atomic % or less, and preferably 0.4 atomic % or more and 0.6 atomic % or less. Balance T is a transition metal element, and inevitably includes Fe. Examples of the transition metal element except for Fe include Co. It is not preferable that the amount of Co substitution of more than 10% leads to a reduction in Bᵣ. A small amount of V, Cr, Mn, Zr, Nb, Mo, Hf, Ta, W, and the like may also be included.

In the present embodiment, in addition to the above-mentioned each element, 0.01 atomic % or more and 1.0 atomic % or less of Cu may be included. Inclusion of Cu lead to formation of an R-Ga—Cu phase together with the R phase and the R-Ga phase on two-grain boundary phase. Formation of an R-Ga—Cu phase leads to a further increase in H_{cJ} as compared with the case of the R-Ga phase alone. The magnet may have the same degree of Al content as usual. The range where known effects are exerted is set at 0.69 atomic % or less, and more preferably 0.3 atomic % or less (including 0 atomic %).

In the composition, the content of Ga is preferably within a range of the following inequality expression (1):

0.8≦<Ga>/( 1/17×100−<B>)≦3.0 (1)

wherein <Ga> is the amount of Ga in terms of atomic %, and <B> is the amount of B in terms of atomic %.

More preferably, the content of Ga is within a range of the following inequality expression (2):

1.03≦<Ga>/( 1/17×100−<B>)≦1.24 (2)

wherein <Ga> is the amount of Ga in terms of atomic %, and <B> is the amount of B in terms of atomic %.

In the case of including Cu, the contents of Ga and Cu are preferably within a range of the following inequality expression (3):

1.0≦<Ga+Cu>/( 1/17×100−<B>)≦3.0 (3)

wherein <Ga+Cu> is the total amount of Ga and Cu in terms of atomic %, and <B> is the amount of B in terms of atomic %.

An atomic number ratio of the amount of B to the amount of R is preferably within a range of the following inequality expression (4):

0.37≦<B>/<R>≦0.42 (4)

wherein <B> is the amount of B in terms of atomic %, and <R> is the amount of R in terms of atomic %.

In any case, setting within preferable range leads to a further suppression of a reduction in Bᵣ and a further increase in H_{cJ}.

### [Method for Producing R-T-B-Based Sintered Magnet]

An example of a method for producing an R-T-B based sintered magnet will be described. The method for producing an R-T-B based sintered magnet includes a step of obtaining an alloy powder, a molding step, a sintering step, and a heat treating step. Each step will be described below.

(1) Step of obtaining Alloy Powder

Metals or alloys of the respective elements are prepared so as to obtain the above-mentioned composition, and a flaky alloy is produced from them using such as a strip casting method. The flaky alloy thus obtained is subjected to hydrogen decrepitation to obtain a coarsely crushed powder having a size of 1.0 mm or less. Next, the coarsely crushed powder is finely pulverized by such as a jet mill to obtain a finely pulverized powder (alloy powder) having a particle diameter D50 (value obtained by a laser diffraction method using an air flow dispersion method (median size)) of 3 to 7 μm. A known lubricant may be used as a pulverization assistant in a coarsely crushed powder before jet mill pulverization, or an alloy powder during and after jet mill pulverization.

### (2) Molding Step

Using the alloy powder thus obtained, molding in a magnetic field is performed to obtain a molded body. The molding in a magnetic field may be performed using known optional methods of molding in a magnetic field including a dry molding method in which a dry alloy powder is loaded in a cavity of a die and then molded while applying a magnetic field, and a wet molding method in which a slurry containing the alloy powder dispersed therein is injected in a cavity of a die and then molded while discharging a dispersion medium of the slurry.

### (3) Sintering Step

The molded body is sintered to obtain a sintered magnet. A known method can be used to sinter the molded body. To avoid oxidation due to an atmosphere during sintering, sintering is preferably performed in a vacuum atmosphere or an atmospheric gas. It is preferable to use, as the atmospheric gas, an inert gas such as helium and argon.

### (4) Heat Treating Step

The sintered magnet thus obtained is preferably subjected to a heat treating for the purpose of improving magnetic properties. Known conditions can be employed for heat treating temperature, heat treating time, and the like. To adjust the size of the sintered magnet, the magnet may be subjected to machining such as grinding. In that case, the heat treating may be performed before or after machining. The sintered magnet may also be subjected to a surface treating. The surface treating may be a known surface treating, and it is possible to perform surface treating, for example, Al vapor deposition, Ni electroplating, resin coating, and the like.

### Examples

The present invention will be described in more detail below by way of Examples, but the present invention is not limited thereto.

Nd having a purity of 99.5% by mass or more, electrolytic iron, electrolytic Co, Al, Cu, Ga, and ferroboron alloy were prepared so that the composition of a sintered magnet became each composition shown in Table 1 and Table 2, and then these raw materials were melted and subjected to casting by a strip casting method to obtain a flaky alloy having a thickness of 0.2 to 0.4 mm. The flaky alloy thus obtained was subjected to hydrogen embrittlement in a pressurized hydrogen atmosphere and then subjected to a dehydrogenation treatment of heating to 550° C. in vacuum and cooling to obtain a coarsely crushed powder. To the coarsely crushed powder thus obtained, zinc stearate was added as a lubricant in the proportion of 0.04% by mass based on 100% by mass of the coarsely crushed powder, followed by mixing. Using an air flow-type pulverizer (jet milling machine), the mixture was subjected to dry pulverization in a nitrogen gas flow to obtain a finely pulverized powder (alloy powder) having a particle diameter D50 (median size) of 4 μm. The oxygen concentration in a nitrogen gas during pulverization was controlled to 50 ppm or less. The particle diameter D50 is the value obtained by a laser diffraction method using an air flow dispersion method.

The alloy powder thus obtained was mixed with a dispersion medium to prepare a slurry. Normal dodecane was used as a solvent, and methyl caprylate was added as a lubricant. Regarding the concentration of the slurry, the proportion of the alloy powder was set at 70% by mass and that of the dispersion medium was set at 30% by mass, while the proportion of the lubricant was set at 0.16% by mass based on 100% by mass of the alloy powder. The slurry was molded in a magnetic field to obtain a molded body. The magnetic field during molding was static magnetic field set at 0.8 MA/m, and the molding pressure was set at 5 MPa. A molding device used was a so-called perpendicular magnetic field molding device (transverse magnetic field molding device) in which a magnetic field application direction and a pressuring direction are perpendicular to each other.

The molded body thus obtained was sintered in vacuum at 1,020° C. for 4 hours to obtain a sintered magnet. The sintered magnet had a density of 7.5 Mg/m³ or more. The sintered body thus obtained was subjected to a heat treating of retaining at 800° C. for 2 hours and cooling to room temperature, followed by retention at 500° C. for 2 hours and cooling to room temperature to produce samples Nos. 1 to 11 of an R-T-B based sintered magnet.

The component analysis results (% by mass and atomic %) of samples Nos. 1 to 11 of the sintered magnet, and the measurements results of oxygen (O), nitrogen (N), and carbon (C) are shown in Table 1 and Table 2. The atomic percentage obtained, when impurities except for oxygen, nitrogen, and oxygen were ignored and the amount of Fe was adjusted so that the total amount became 100% by mass, and the values of <Ga>/( 1/17×100−<B>), <Ga+Cu>/( 1/17×100−<B>), and <B>/<R> (in atomic ratio in any case) determined from these results are shown in Table 1 and Table 2.

TABLE 1

| | | | | | | | | | | | | Ga/ | (Ga + Cu)/ | | |
|---|---|---|---|---|---|---|---|---|---|---|---|---|---|---|---|
| Sample | | Composition of sintered magnet (% by mass) | | | | | | | | | | (1/17 × | (1/17 × | | |
| No. | | Nd | Fe | B | Co | Ga | Cu | Al | O | N | C | 100 − B) | 100 − B) | B/R | Remarks |
| 1 | Mass % | 29.20 | bal. | 0.88 | 0.50 | 0.20 | 0.10 | 0.28 | 0.10 | 0.05 | 0.10 | — | — | — | Example of the |
| | Atomic % | 13.04 | bal. | 5.24 | 0.55 | 0.23 | 0.10 | 0.67 | 0.40 | 0.23 | 0.54 | 0.36 | 0.52 | 0.40 | present |
| | | | | | | | | | | | | | | | invention |
| 2 | Mass % | 29.50 | bal. | 0.91 | 0.50 | 0.50 | 0.10 | 0.28 | 0.10 | 0.05 | 0.10 | — | — | — | Example of the |
| | Atomic % | 13.18 | bal. | 5.43 | 0.55 | 0.46 | 0.10 | 0.67 | 0.40 | 0.23 | 0.54 | 1.01 | 1.24 | 0.41 | present |
| | | | | | | | | | | | | | | | invention |
| 3 | Mass % | 31.00 | bal. | 0.90 | 0.50 | 0.50 | 0.10 | 0.28 | 0.10 | 0.05 | 0.10 | — | — | — | Example of the |
| | Atomic % | 14.01 | bal. | 5.43 | 0.55 | 0.47 | 0.10 | 0.68 | 0.41 | 0.23 | 0.54 | 1.03 | 1.25 | 0.39 | present |
| | | | | | | | | | | | | | | | invention |
| 4 | Mass % | 32.40 | bal. | 0.89 | 0.50 | 0.60 | 0.00 | 0.28 | 0.10 | 0.05 | 0.10 | — | — | — | Example of the |
| | Atomic % | 14.80 | bal. | 5.42 | 0.56 | 0.57 | 0.00 | 0.68 | 0.41 | 0.24 | 0.55 | 1.24 | 1.24 | 0.37 | present |
| | | | | | | | | | | | | | | | invention |
| 5 | Mass % | 32.40 | bal. | 0.89 | 0.50 | 0.50 | 0.10 | 0.28 | 0.10 | 0.05 | 0.10 | — | — | — | Example of the |
| | Atomic % | 14.80 | bal. | 5.42 | 0.56 | 0.47 | 0.10 | 0.68 | 0.41 | 0.24 | 0.55 | 1.03 | 1.26 | 0.37 | present |
| | | | | | | | | | | | | | | | invention |
| 6 | Mass % | 32.70 | bal. | 0.91 | 0.50 | 1.00 | 0.10 | 0.28 | 0.10 | 0.05 | 0.10 | — | — | — | Example of the |
| | Atomic % | 14.97 | bal. | 5.56 | 0.56 | 0.95 | 0.10 | 0.69 | 0.41 | 0.24 | 0.55 | 2.93 | 3.25 | 0.37 | present |
| | | | | | | | | | | | | | | | invention |
| 7 | Mass % | 31.00 | bal. | 0.85 | 0.50 | 0.50 | 0.10 | 0.28 | 0.10 | 0.05 | 0.10 | — | — | — | Comparative |
| | Atomic % | 14.07 | bal. | 5.02 | 0.56 | 0.47 | 0.10 | 0.68 | 0.41 | 0.23 | 0.55 | 0.55 | 0.67 | 0.36 | Example |
| 8 | Mass % | 31.00 | bal. | 0.88 | 0.50 | 0.10 | 0.10 | 0.28 | 0.10 | 0.05 | 0.10 | — | — | — | Comparative |
| | Atomic % | 14.01 | bal. | 5.31 | 0.55 | 0.09 | 0.10 | 0.68 | 0.41 | 0.23 | 0.54 | 0.16 | 0.34 | 0.38 | Example |
| 9 | Mass % | 28.90 | bal. | 0.90 | 0.50 | 0.25 | 0.10 | 0.28 | 0.10 | 0.05 | 0.10 | — | — | — | Comparative |
| | Atomic % | 12.86 | bal. | 5.34 | 0.55 | 0.23 | 0.10 | 0.67 | 0.40 | 0.23 | 0.54 | 0.43 | 0.61 | 0.42 | Example |

TABLE 2

| | | | | | | | | | | | | | Ga/ | (Ga + Cu)/ | | |
|---|---|---|---|---|---|---|---|---|---|---|---|---|---|---|---|---|
| Sample | | Composition of sintered magnet (% by mass) | | | | | | | | | | | (1/17 × | (1/17 × | | |
| No. | | Nd | Pr | Fe | B | Co | Ga | Cu | Al | O | N | C | 100 − B) | 100 − B) | B/R | Remarks |
| 10 | Mass % | 31.50 | 0.00 | bal. | 0.90 | 0.50 | 0.50 | 0.00 | 0.28 | 0.10 | 0.05 | 0.10 | — | — | — | Example of |
| | Atomic % | 14.28 | 0.00 | bal. | 5.44 | 0.56 | 0.47 | 0.00 | 0.69 | 0.41 | 0.23 | 0.55 | 1.07 | 1.07 | 0.38 | the present |
| | | | | | | | | | | | | | | | | invention |
| 11 | Mass % | 23.20 | 7.80 | bal. | 0.90 | 1.00 | 0.55 | 0.00 | 0.28 | 0.10 | 0.05 | 0.10 | — | — | — | Example of |
| | Atomic % | 10.48 | 3.61 | bal. | 5.42 | 1.11 | 0.51 | 0.00 | 0.68 | 0.41 | 0.23 | 0.54 | 1.12 | 1.12 | 0.39 | the present |
| | | | | | | | | | | | | | | | | invention |

Next, each of samples Nos. 1 to 11 of the sintered magnet was cut by machining, followed by polishing of a cross section and further SEM observation. Five visual fields of a first grain boundary phase located between two main phases (i.e. two-grain boundary phase) of which the length in an observation cross section is 3 μm or more were selected at random. For each visual field, the sample was processed into a pillar shape of about 5 μm in thickness×about 20 μm in width×about 15 μm in height in a face of SEM observation so as to include the selected first grain boundary phase by a microsampling method using focused ion beam (FIB). Furthermore, a sample for transmission electron microscope (TEM) was produced by slice processing until the thickness became 80 nm or less.

The sample thus obtained was observed by a transmission electron microscope (TEM) to measure the thickness of the first grain boundary phase. After confirming that the length of the two-grain boundary phase in the sample is 3 μm or more, the thickness of the first grain boundary phase of the region (having a length of 2 μm or more) excluding the region within about 0.5 μm from near the border with a second grain boundary phase located between three or more main phases was evaluated. The maximum value was regarded as the thickness of the grain boundary phase. After determining the region where the thickness of the two-grain boundary phase is the largest, the maximum value of the thickness of the two-grain boundary phase was measured by increasing a magnification of TEM so as to accurately measure the thickness. Similar analysis was performed for all five samples of the first grain boundary phase. The results of the average are shown in Table 3.

The samples Nos. 1 to 11 of the sintered magnet were machined to produce samples of 7 mm in length×7 mm in width×7 mm in thickness, and Bᵣ and H_{cJ} of each sample were measured by a B—H tracer. The results thus obtained are shown in Table 3.

TABLE 3

| | Thickness of first grain | | | |
|---|---|---|---|---|
| Sample | boundary phase | Br | HcJ | |
| No. | (average, n = 5) [nm] | [T] | [MA/m] | Remarks |
| 1 | 5.8 | 1.39 | 1.30 | Example of the present |
| | | | | invention |
| 2 | 6.3 | 1.40 | 1.35 | Example of the present |
| | | | | invention |
| 3 | 15.2 | 1.36 | 1.55 | Example of the present |
| | | | | invention |
| 4 | 18.9 | 1.30 | 1.57 | Example of the present |
| | | | | invention |
| 5 | 24.8 | 1.30 | 1.60 | Example of the present |
| | | | | invention |
| 6 | 9.8 | 1.30 | 1.43 | Example of the present |
| | | | | invention |
| 7 | 4.1 | 1.34 | 1.16 | Comparative Example |
| 8 | 3.9 | 1.37 | 1.03 | Comparative Example |
| 9 | 3.3 | 1.39 | 1.00 | Comparative Example |
| 10 | 14.2 | 1.33 | 1.52 | Example of the present |
| | | | | invention |
| 11 | 16.7 | 1.35 | 1.53 | Example of the present |
| | | | | invention |

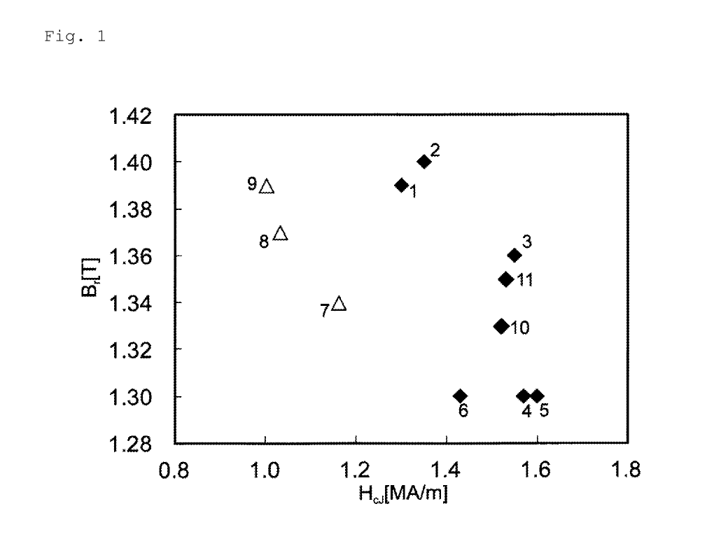

As shown in Table 3, all samples Nos. 1 to 6, 10, and 11 of the present invention, in which a first grain boundary phase (i.e. two-grain boundary phase) has a thickness of 5 nm or more and 30 nm or less, exhibited high Bᵣ and high H_{cJ}. It was also revealed that samples Nos. 3, 4, 5, 10, and 11, in which a first grain boundary phase has a thickness of 10 nm or more, exhibited particularly high H_{cJ}. The results of Bᵣ and H_{cJ} in Table 3 are shown in FIG. 1. Black rhombus-shaped plots 1 to 6, 10, and 11 in FIG. 1 indicate samples Nos. 1 to 6, 10, and 11 of Examples of the present invention, while white triangle-shaped plots 7 to 9 indicate samples Nos. 7 to 9 of Comparative Examples. As shown in FIG. 1, when a comparison is made between two samples in which the composition except for the amount of B is almost the same, specifically, between sample No. 3 (Example of the present invention) in which the first grain boundary phase has a thickness of 15.2 nm and sample No. 7 (Comparative Example) in which the first grain boundary phase has a thickness of 4.1 nm, it is apparent that sample No. 3 (Example of the present invention) exhibits higher Bᵣ and higher H_{cJ}.

As schematically shown in FIG. 2(b) which is an enlarged view of a cross section of the sintered magnet shown in FIG. 2(a), there was a case where a region having a larger thickness and a region having a smaller thickness coexist in the first grain boundary phase. In such case, the maximum value of the region having a larger thickness was defined as the thickness of the first grain boundary phase. Regarding the first grain boundary phase, the region excluding the region within at least 0.5 μm from the second grain boundary phase confirmed in the observation visual fields of TEM is evaluated.

Regarding the composition of the grain boundary phase when TEM observation of sample No. 5 was performed, point analysis (beam size of 2 nm) of Nd, Fe, Co, Cu, Ga, Al, and O was performed by energy dispersive X-ray spectroscopy (EDX). As a result of calculation of the atomic percentage from the analysis results of these elements, the proportion of (Fe+Co) was 16 atomic %

### INDUSTRIAL APPLICABILITY

The R-T-B based sintered magnet according to the present invention can be suitably employed in motors for hybrid vehicles and electric vehicles.

The present application claims priority on Japanese Patent Application No. 2013-071833 filed on Mar. 29, 2013 as a basic application, the disclosure of which is incorporated by reference herein.

### DESCRIPTION OF REFERENCE NUMERALS

20, 22: first grain boundary phase
24: Region having larger thickness
26: Region having smaller thickness
30, 32: second grain boundary phase
35A, 35B: Border
40, 42: Main phase

1-11. (canceled)

12. An R-T-B based sintered magnet including an Nd₂Fe₁₄B type compound as a main phase comprising:
the main phase;
a first grain boundary phase located between two main phases; and
a second grain boundary phase located between three or more main phases,
wherein the first grain boundary phase having a thickness of 5 nm or more and 30 nm or less is present, and
the composition of the R-T-B based sintered magnet comprises:
R: 13.0 atomic % or more and 15 atomic % or less (R being Nd and/or Pr),
B: 5.2 atomic % or more and 5.6 atomic % or less,
Ga: 0.2 atomic % or more and 1.0 atomic % or less,
Al: 0.69 atomic % or less (including 0 atomic %), and
balance being T (T is a transition metal element and inevitably includes Fe) and inevitable impurities.

13. The R-T-B based sintered magnet according to claim 12, further comprising:
Cu: 0.01 atomic % or more and 1.0 atomic % or less.

14. The R-T-B based sintered magnet according to claim 12, wherein the content of Al is 0.3 atomic % or less (including 0 atomic %).

15. The R-T-B based sintered magnet according to claim 12, wherein the content of B is 5.2 atomic % or more and 5.43 atomic % or less.

16. The R-T-B based sintered magnet according to claim 12, wherein the content of Ga is 0.4 atomic % or more and 0.6 atomic % or less.

17. The R-T-B based sintered magnet according to claim 12, satisfying the following inequality expression (1):
0.8≦<Ga>/(1/17×100−<B>)<3.0 (1)
wherein <Ga> is the amount of Ga in terms of atomic %, and <B> is the amount of B in terms of atomic %.

18. The R-T-B based sintered magnet according to claim 17, satisfying the following inequality expression (2):
1.03≦<Ga>/( 1/17×100−<B>)≦1.24 (2)
wherein <Ga> is the amount of Ga in terms of atomic %, and <B> is the amount of B in terms of atomic %.

19. The R-T-B based sintered magnet according to claim 13, satisfying the following inequality expression (3):
1.0≦<Ga+Cu>/( 1/17×100−<B>)≦3.0 (3)
wherein <Ga+Cu> is the total amount of Ga and Cu in terms of atomic %, and <B> is the amount of B in terms of atomic %.

20. The R-T-B based sintered magnet according to claim 12, wherein the first grain boundary phase has a thickness of 10 nm or more and 30 nm or less.

21. The R-T-B based sintered magnet according to claim 12, wherein an atomic number ratio of the amount of B to the amount of R satisfies the following inequality expression (4):
0.37≦<B>/<R>≦0.42 (4)
wherein <B> is the amount of B in terms of atomic %, and <R> is the amount of R in terms of atomic %.

22. The R-T-B based sintered magnet according to claim 12, wherein the content of Fe or (Fe+Co) of the first grain boundary phase is 20 atomic % or less (including 0 atomic %).
